(19) United States
(12) Patent Application Publication
(10) Pub. No.: US 2019/0158297 A1
(43) Pub. Date: May 23, 2019

(54) COMMUNICATION SYSTEM AND IN-VEHICLE COMMUNICATION APPARATUS

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka (JP)

(72) Inventor: Yasuhiro YABUUCHI, Yokkaichi (JP)

(21) Appl. No.: 16/091,452

(22) PCT Filed: Mar. 23, 2017
(86) PCT No.: PCT/JP2017/011688

§ 371 Date: Oct. 4, 2018

(30) Foreign Application Priority Data
Apr. 5, 2016 (JP) 2016-075886

(51) Int. Cl. H04L 9/32; H04L 9/30; H04W 12/04

(52) U.S. Cl. CPC H04L 9/3263; H04W 12/04; H04L 9/30

(57) ABSTRACT

Provided is a communication system in which an in-vehicle communication apparatus mounted in a vehicle is capable of acquiring update information of a system configuration relating to issuance of certificate information, and an in-vehicle communication apparatus that is included in this communication system. An in-vehicle communication apparatus mounted in a vehicle acquires update information related to an increase or decrease in the system configuration of a certificate information issuing system from an update information distribution server apparatus, via a roadside communication apparatus installed on a road. The in-vehicle communication apparatus, in a case of becoming communicable with the roadside communication apparatus, acquires function list information from the roadside communication apparatus, and determines whether this roadside communication apparatus has a relay function. The in-vehicle communication apparatus acquires update information from the update information distribution server apparatus periodically in a predetermined cycle, such as daily, weekly or monthly, for example.

### CROSS-REFERENCE TO RELATED APPLICATIONS

This application is the U.S. national stage of PCT/JP2017/011688 filed Mar. 23, 2017, which claims priority of Japanese Patent Application No. JP 2016-075886 filed Apr. 5, 2016.

### TECHNICAL FIELD

The present disclosure relates to a communication system that communicates using certificate information that is hierarchically created, and to an in-vehicle communication apparatus that is included in this communication system.

### BACKGROUND

Vehicles in recent years are equipped with an in-vehicle communication apparatus having a wireless communication function such as road-vehicle communication for performing wireless communication with roadside communication apparatuses installed on the road and vehicle-vehicle communication for performing wireless communication with other vehicles, enabling various types of information exchange to be performed with apparatuses external to the vehicle. A high level of security is desired in communication external to the vehicle that is performed by the in-vehicle communication apparatus, and communication technologies such as electronic signatures and encryption are generally used.

JP 2013-58140A, for example, proposes a communication apparatus that generates a vehicle ID from the vehicle number of its own vehicle and transmits the vehicle ID in addition to transmission data, and that also generates a vehicle ID after acquiring the vehicle number of another vehicle with which communication is to be performed and judges the validity of data received from the other vehicle through comparison with the vehicle ID attached to the received data.

In the case of performing communication that utilizes electronic signatures, encryption or the like, it is effective to utilize an issuing system for digital certificate information that is constituted by one root certificate authority and a plurality of sub-certificate authorities, for example. In this system, the root certificate authority issues the certificate information of the sub-certificate authorities and the sub-certificate authorities issue the certificate information of the in-vehicle communication apparatus. The certificate information that is issued by the sub-certificate authorities includes the certificate information of the sub-certificate authorities, in addition to information generated for the in-vehicle communication apparatus. The in-vehicle communication apparatus attaches an electronic signature including its own public key information and certificate information issued by the sub-certificate authorities to data to be transmitted. Another communication apparatus that receives this data is able to judge the validity of the received data, by judging the validity of the certificate information of the in-vehicle communication apparatus that transmitted the data, which is included in the electronic signature attached to the received data, and the validity of the certificate information of the sub-certificate authority that issued this certificate information.

In a system that hierarchically creates certificate information using a root certificate authority and sub-certificate authorities, the system configuration could possibly be updated, such as an existing sub-certificate authority being removed or a new sub-certificate authority being added, for example. In the case where a sub-certificate authority is removed, certificate information issued by this sub-certificate authority needs to be treated as invalid. Also, in the case where a sub-certificate authority is added, data to which certificate information issued by this sub-certificate authority is attached could possibly be transmitted and received, and thus information (certificate information of the newly added sub-certificate authority, etc.) for judging the validity of this certificate information needs to be acquired. However, there is a problem that it is difficult for a conventional in-vehicle communication apparatus mounted in a vehicle to acquire information related to updating of the system configuration, such as an increase or decrease in sub-certificate authorities.

The present disclosure was made in view of these circumstances, and an object thereof is to provide a communication system in which an in-vehicle communication apparatus mounted in a vehicle is capable of acquiring update information of a system configuration relating to issuance of certificate information, and to an in-vehicle communication apparatus that is included in this communication system.

### SUMMARY

A communication system according to the present disclosure is a communication system including an in-vehicle communication apparatus mounted in a vehicle, a low-order server apparatus configured to create digital certificate information to be used by the in-vehicle communication apparatus in communication, and a high-order server apparatus configured to create digital certificate information related to the low-order server apparatus, the communication system further including a roadside communication apparatus installed on a road and configured to perform wireless communication with the in-vehicle communication apparatus, and an update information distribution server apparatus configured to distribute update information related to an increase or decrease in low-order server apparatuses, and the in-vehicle communication apparatus including a wireless communication unit configured to wirelessly communicate with the roadside communication apparatus, and an update information acquisition unit configured to acquire update information from the update information distribution server apparatus via the roadside communication apparatus.

Also, the communication system according to the present disclosure is configured such that the update information that is acquired by the update information acquisition unit is information relating to an increase in low-order server apparatuses, and includes certificate information created by the high-order server apparatus for an added low-order server apparatus.

Also, the communication system according to the present disclosure is configured such that the in-vehicle communication apparatus includes a certificate information determination unit configured to, in a case where the update information acquisition unit acquires update information, determine a validity of certificate information of the low-order server apparatus included in the update information, based on certificate information of the high-order server apparatus.

Also, the communication system according to the present disclosure is configured such that the update information that is acquired by the update information acquisition unit is information related to a decrease in low-order server apparatuses, and includes information related to an invalidated low-order server apparatus.

Also, the communication system according to the present disclosure is configured such that the in-vehicle communication apparatus includes a relay function determination unit configured to wirelessly communicate with the roadside communication apparatus, using the wireless communication unit, and determine whether the roadside communication apparatus has a function of relaying communication with the update information distribution server apparatus.

Also, the communication system according to the present disclosure is configured such that the update information acquisition unit periodically acquires the update information.

Also, the communication system according to the present disclosure is configured such that the in-vehicle communication apparatus includes a position information acquisition unit configured to acquire position information of the vehicle, and the update information acquisition unit acquires the update information according to the position information that is acquired by the position information acquisition unit.

Also, an in-vehicle communication apparatus according to the present disclosure is an in-vehicle communication apparatus to be mounted in a vehicle and configured to perform communication using digital certificate information created by at least one low-order server apparatus for which a high-order server apparatus creates digital certificate information, including a wireless communication unit configured to wirelessly communicate with a roadside communication apparatus installed on a road, and an update information acquisition unit configured to acquire update information related to an increase or decrease in low-order server apparatuses and/or high-order server apparatuses from an update information distribution server apparatus configured to distribute the update information, via the roadside communication apparatus.

In the present disclosure, an in-vehicle communication apparatus mounted in a vehicle acquires, via a roadside communication apparatus installed on the road, update information related to an increase or decrease in high-order server apparatuses (root certificate authorities) and the low-order server apparatuses (sub-certificate authorities) that create digital certificate information from an update information distribution server apparatus. The in-vehicle communication apparatus is thereby able to communicate with the update information distribution server apparatus via the roadside communication apparatus and acquire update information, in the case where the vehicle enters within wireless communication range of the roadside communication apparatus, while the vehicle is travelling or the like.

Also, in the present disclosure, the update information that is acquired from the update information distribution server apparatus is given as information relating to an increase in sub-certificate authorities. In this case, the update information may include certificate information created by the root certificate authority for the added sub-certificate authority. The in-vehicle communication apparatus, having acquired the update information, is thereby able to transmit and receive data including certificate information created by the added sub-certificate authority.

Also, in this case, the in-vehicle communication apparatus determines the validity of the certificate information of the sub-certificate authority that is included in the acquired update information, based on the certificate information of the root certificate authority that created the certificate information of the sub-certificate authority. The reliability of the certificate information of the sub-certificate authority that is newly acquired can thereby be enhanced.

Also, in the present disclosure, the update information that is acquired from the update information distribution server apparatus is given as information relating to a decrease in sub-certificate authorities. In this case, information that is able to distinguish the invalidated sub-certificate authority is included in the update information. The in-vehicle communication apparatus, having received the update information, is thereby able to perform processing such as discarding and not using certificate information created by the invalidated sub-certificate authority in subsequent communication or discarding received data to which certificate information created by the invalidated sub-certificate authority is attached, thereby enabling the reliability of communication to be enhanced.

Also, in the present disclosure, the in-vehicle communication apparatus determines whether the roadside communication apparatus has a function of relaying communication with the update information distribution server apparatus, by communicating with the roadside communication apparatus. The in-vehicle communication apparatus is thereby able to efficiently and reliably communicate with the update information distribution server apparatus, according to the functions of the roadside communication apparatus.

Also, in the present disclosure, the in-vehicle communication apparatus periodically acquires update information from the update information distribution server apparatus in a predetermined cycle, such as daily, weekly or monthly, for example. The in-vehicle communication apparatus is thereby able to periodically grasp the latest configuration of the root certificate authority and the sub-certificate authorities.

Also, in the present disclosure, the in-vehicle communication apparatus acquires the position information of a vehicle that utilizes GPS (Global Positioning System) or the like. The in-vehicle communication apparatus acquires update information from the update information distribution server apparatus, in cases such as where the vehicle passes over a prefectural, state, national or other boundary, for example, according to the position information on the vehicle. The in-vehicle communication is thereby able to acquire update information suitable for the position of the vehicle, in the case where a root certificate authority or sub-certificate authorities are provided every prefecture, state, country or the like.

### Advantageous Effects of Disclosure

In the case of the present disclosure, it becomes possible for an in-vehicle communication apparatus to acquire update information of a system configuration relating to issuance of certificate information, by adopting a configuration in which the in-vehicle communication apparatus acquires update information related to an increase or decrease in root certificate authorities and sub-certificate authorities from an update information distribution server apparatus via a roadside communication apparatus.

### BRIEF DESCRIPTION OF DRAWINGS

FIG. 1 is a schematic diagram showing the configuration of a communication system according to an embodiment.

FIG. 2 is a schematic diagram showing an exemplary configuration of a certificate information issuing system.

FIG. 3 is a block diagram showing the configuration of an in-vehicle communication apparatus.

FIG. 4 is a block diagram showing the configuration of a roadside communication apparatus.

FIG. 5 is a block diagram showing the configuration of an update information distribution server apparatus.

FIG. 6 is a schematic diagram showing an exemplary change in the configuration of the certificate information issuing system.

FIG. 7 is a schematic diagram showing an exemplary change in the configuration of the certificate information issuing system.

FIG. 8 is a timing chart for illustrating processing for transmitting update information.

FIG. 9 is a flowchart showing the procedure of update information acquisition processing that is performed by the in-vehicle communication apparatus.

FIG. 10 is a block diagram showing the configuration of an in-vehicle communication apparatus according to a modification.

### DETAILED DESCRIPTION OF PREFERRED EMBODIMENTS

### Outline of Communication System

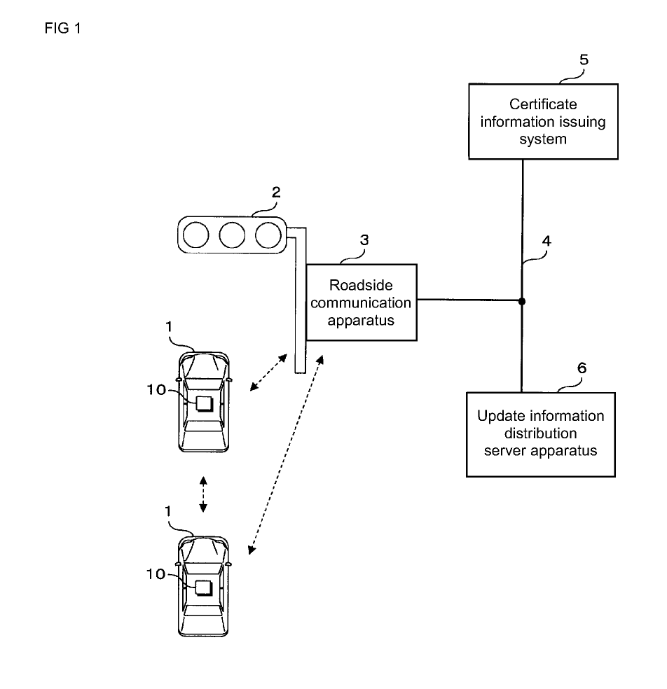

FIG. 1 is a schematic diagram showing the configuration of a communication system according to the present embodiment. In the communication system according to the present embodiment, an in-vehicle communication apparatus 10 mounted in a vehicle 1 is able to perform wireless communication with an in-vehicle communication apparatus 10 mounted in another vehicle 1, that is, so-called vehicle-vehicle communication. Also, the in-vehicle communication apparatus 10 is able to perform wireless communication with a roadside communication apparatus 3 installed in a traffic light 2 on the road, that is, so-called road-vehicle communication. The in-vehicle communication apparatus 10, in the case of transmitting data to another apparatus by communication such as vehicle-vehicle communication or road-vehicle communication, transmits transmission data to the other apparatus with an electronic signature attached thereto, in order to prevent spoofing, data tampering or the like by a malicious third party. The apparatus, having received the data, determines the validity of the received data, based on the electronic signature attached to the received data.

The roadside communication apparatus 3 has a function of performing communication with a server apparatus and the like via a network 4 such as the Internet. Also, the roadside communication apparatus 3 according to the present embodiment has a function of relaying communication between the in-vehicle communication apparatus 10 of the vehicle 1 and the server apparatus and the like connected to the network 4. The in-vehicle communication apparatus 10 is thereby able to communicate, via the roadside communication apparatus 3, with a certificate information issuing system 5, an update information distribution server apparatus 6 and the like connected to the network 4.

The communication system according to the present embodiment performs communication utilizing so-called public-key encryption technology. The in-vehicle communication apparatus 10 thus has a private key for encrypting data to be transmitted or a hash value of this data, and a public key for decrypting encrypted data. The in-vehicle communication apparatus 10 wirelessly transmits transmission data to another in-vehicle communication apparatus 10, the roadside communication apparatus 3 or the like with an electronic signature that includes encrypted data encrypted using a private key, a public key for decrypting this encrypted data and digital certificate information certifying that this public key is valid attached thereto.

The digital certificate information that is needed at this time is issued to each in-vehicle communication apparatus 10 by the certificate information issuing system 5. The in-vehicle communication apparatus 10 stores the digital certificate information issued by the certificate information issuing system 5, and uses the stored digital certificate information whenever data transmission is performed. A period of validity is, however, set for digital certificate information that is issued by the certificate information issuing system 5, and the in-vehicle communication apparatus 10 needs to request the certificate information issuing system 5 for issuance of digital certificate information and acquire the new digital certificate information, in the case where this period of validity expires or before it expires. In the communication system according to the present embodiment, the request for issuance of digital certificate information from the in-vehicle communication apparatus 10 to the certificate information issuing system 5 and the transmission of the digital certificate information from the certificate information issuing system 5 to the in-vehicle communication apparatus 10 can be performed via the roadside communication apparatus 3.

The certificate information issuing system 5 is formed in a tree configuration constituted by a root certificate authority and a plurality of sub-certificate authorities. One sub-certificate authority issues digital certificate information to the in-vehicle communication apparatus 10 of each vehicle 1. Note that the tree configuration of the certificate information issuing system 5 constituted by the root certificate authority and the sub-certificate authorities could possibly be changed such as by removing any of the sub-certificate authorities or adding new sub-certificate authorities, for example. In the case where a sub-certificate authority is removed, the digital certificate information issued by this sub-certificate authority needs to be revoked. Also, in the case where a new sub-certificate authority is added, each in-vehicle communication apparatus 10 needs to acquire information relating to this sub-certificate authority (digital certificate information issued for this sub-certificate authority by the root certificate authority).

The update information distribution server apparatus 6 is a server apparatus that distributes update information relating to a configuration of the certificate information issuing system 5 such as described above. The in-vehicle communication apparatus 10 makes an inquiry for update information to the update information distribution server apparatus 6, in cases such as where a predetermined period elapses, for example. In response to this inquiry, the update information distribution server apparatus 6 notifies the in-vehicle communication apparatus 10 whether there is a change in the configuration of the certificate information issuing system 5 and, if there is a change, transmits update information including the changed contents to the in-vehicle communication apparatus 10. In the communication system according to the present embodiment, the inquiry from the in-vehicle communication apparatus 10 to the update information distribution server apparatus 6 and transmission of the update information from the update information distribution server apparatus 6 to the in-vehicle communication apparatus 10 can be performed via the roadside communication apparatus 3. Note that, in FIG. 1, the update information distribution server apparatus 6 is provided externally to the certificate information issuing system 5, but the update information distribution server apparatus 6 may be included in the certificate information issuing system 5.

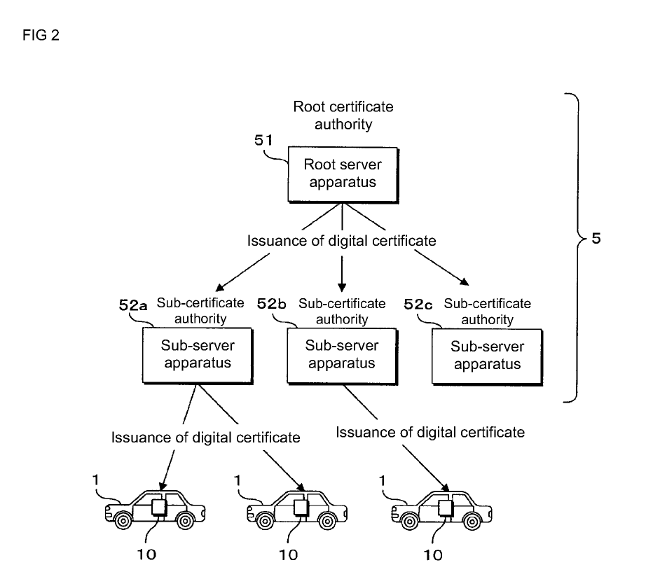

FIG. 2 is a schematic diagram showing an exemplary configuration of the certificate information issuing system 5. The certificate information issuing system 5 according to the present embodiment is constituted to include one root certificate authority and three sub-certificate authorities. The certificate information issuing system 5 is a tree configuration in which the root certificate authority is set at a higher level, and the three sub-certificate authorities are each connected to the root certificate authority. The root certificate authority is realized by a root server apparatus 51, and the three sub-certificate authorities are respectively realized by sub-server apparatuses 52a to 52c. Each of these server apparatuses need not be a standalone apparatus, and may be realized through the collaboration of a plurality of apparatuses. Also, for example, a plurality of server apparatuses may in actuality be realized by a single apparatus, such as the sub-server apparatuses 52a and 52b in actuality being realized by a single apparatus. Also, these server apparatuses need not be arranged proximally, and the server apparatuses may be arranged remotely as long as information can be mutually exchanged via a network such as the Internet. Note that, in the following, the root server apparatus 51 that realizes the root certificate authority is simply referred to as the root certificate authority 51, and the sub-server apparatuses 52a to 52c that realize the sub-certificate authorities are simply referred to as the sub-certificate authorities 52a to 52c.

The root certificate authority 51 authenticates the sub-certificate authorities 52a to 52c. That is, the root certificate authority 51 performs processing for issuing digital certificate information certifying the validity of the public keys of the sub-certificate authorities 52a to 52c. The sub-certificate authorities 52a to 52c authenticate the in-vehicle communication apparatus 10 of the vehicle 1. That is, the sub-certificate authorities 52a to 52c perform processing for issuing digital certificate information certifying the validity of the public key of each in-vehicle communication apparatus 10. The digital certificate information of the in-vehicle communication apparatus 10 that is issued by the sub-certificate authorities 52a to 52c includes the digital certificate information of the sub-certificate authorities 52a to 52c that is issued by the root certificate authority 51. The in-vehicle communication apparatus 10, having acquired digital certificate information from the sub-certificate authorities 52a to 52c or having acquired digital certificate information attached to received data, is thereby able to determine whether the acquired digital certificate information was issued by valid sub-certificate authorities 52a to 52c, by determining the validity of the digital certificate information of the sub-certificate authorities 52a to 52c that is included in the acquired digital certificate information.

### System Configuration

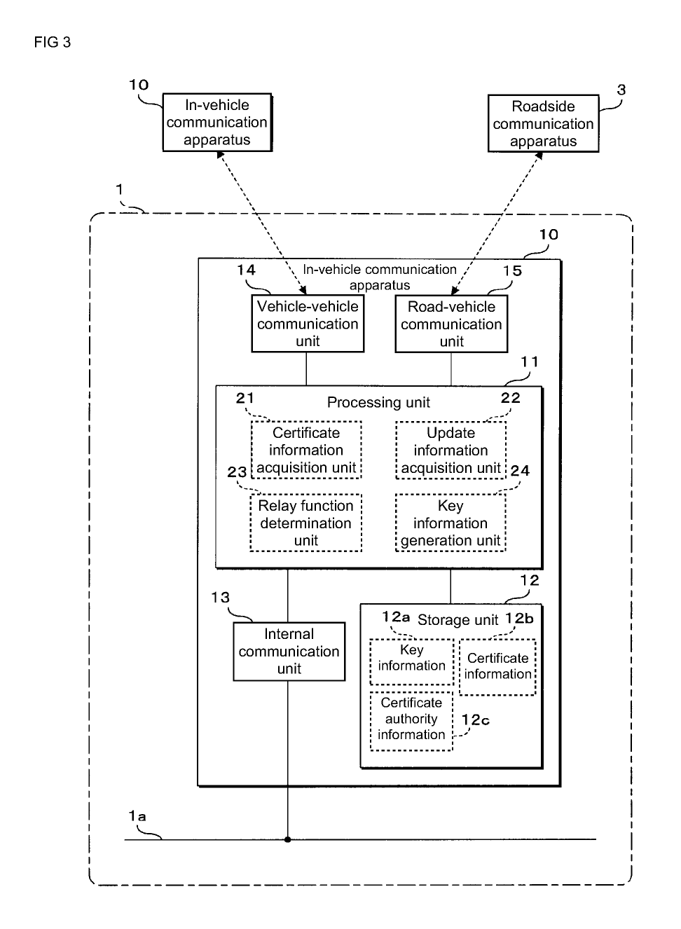

FIG. 3 is a block diagram showing the configuration of the in-vehicle communication apparatus 10. The in-vehicle communication apparatus 10 that is mounted in the vehicle 1 is configured to be provided with a processing unit 11, a storage unit 12, an internal communication unit 13, a vehicle-vehicle communication unit 14, a road-vehicle communication unit 15 and the like. The processing unit 11 is constituted using a computational processing unit such as a CPU (Central Processing Unit) or an MPU (Micro-Processing Unit), and performs various types of computational processing related to communication, by reading out and executing programs stored in the storage unit 12 or a ROM (Read-Only Memory) which is not illustrated.

The storage unit 12 is constituted using a nonvolatile memory device such as an EEPROM (Electrically Erasable Programmable Read-Only Memory) or a flash memory, for example. The storage unit 12 stores programs that are executed by the processing unit 11, various types of data that are used in processing by the processing unit 11, and the like, for example. In the present embodiment, the storage unit 12 stores key information 12a, certificate information 12b and certificate authority information 12c. The key information 12a includes information on the private key and public key of the in-vehicle communication apparatus 10 itself that are required in communication. The certificate information 12b is digital certificate information issued by the certificate information issuing system 5, and is digital certificate information certifying the validity of the public key of the key information 12a. The certificate authority information 12c is information relating to the root certificate authority 51 and the sub-certificate authorities 52a to 52c that constitute the certificate information issuing system 5, and includes information such as the public keys or digital certificate information of these certificate authorities, for example. Also, the certificate authority information 12c can include update information acquired from the update information distribution server apparatus 6.

The internal communication unit 13 communicates with other in-vehicle devices mounted in the vehicle 1 (e.g., body ECU (Electronic Control Unit), car navigation apparatus, etc.), via an internal network 1a such as a CAN (Controller Area Network) provided within the vehicle 1. The internal communication unit 13 performs data transmission by converting data for transmission provided by the processing unit 11 into an electrical signal and outputting the electrical signal to a communication line constituting the internal network 1a, and also receives data by sampling and acquiring a potential of the communication line and provides the received data to the processing unit 11.

The vehicle-vehicle communication unit 14 wirelessly communicates with the in-vehicle communication apparatus 10 mounted in other vehicles 1. The vehicle-vehicle communication unit 14 performs data transmission to other in-vehicle communication apparatuses 10 by outputting a signal obtained through modulating data for transmission provided by the processing unit 11 from an antenna, and also receives data from other in-vehicle communication apparatuses 10 by demodulating signals received with the antenna and provides the received data to the processing unit 11. Note that an electronic signature generated using the key information 12a and the certificate information 12b stored in the storage unit 12 is attached to data that is transmitted by the vehicle-vehicle communication unit 14.

The road-vehicle communication unit 15 wirelessly communicates with the roadside communication apparatus 3 provided on the road. The road-vehicle communication unit 15 performs data transmission to the roadside communication apparatus 3 by outputting a signal obtained through modulating data for transmission provided by the processing unit 11 from the antenna, and also receives data from the roadside communication apparatus 3 by demodulating signals received with the antenna and provides the received data to the processing unit 11. Note that an electronic signature generated using the key information 12a and the certificate information 12b stored in the storage unit 12 is attached to data that is transmitted by the road-vehicle communication unit 15.

Also, in the processing unit 11 of the in-vehicle communication apparatus 10 according to the present embodiment, a certificate information acquisition unit 21, an update information acquisition unit 22, a relay function determination unit 23, and a key information generation unit 24 and the like are realized as software-based functional blocks, by executing programs stored in the storage unit 12, the ROM or the like. The certificate information acquisition unit 21 utilizes road-vehicle communication with the roadside communication apparatus 3 through the road-vehicle communication unit 15, communicates with the sub-certificate authorities 52a to 52c of the certificate information issuing system 5 via the roadside communication apparatus 3, and performs processing for acquiring digital certificate information that is issued by the sub-certificate authorities 52a to 52c.

The update information acquisition unit 22 communicates with the update information distribution server apparatus 6 by road-vehicle communication via the roadside communication apparatus 3, and performs processing for acquiring update information from the update information distribution server apparatus 6. In the present embodiment, the update information acquisition unit 22 acquires update information periodically in a predetermined cycle, such as daily, weekly or monthly, for example.

The relay function determination unit 23 performs processing for determining whether the roadside communication apparatus 3 with which road-vehicle communication was performed by the road-vehicle communication unit 15 has a function of relaying communication between the in-vehicle communication apparatus 10 and the certificate information issuing system 5, the update information distribution server apparatus 6 and the like connected to the network 4. For example, the roadside communication apparatus 3 transmits list information of its own functions, periodically or continuously, or in response to an inquiry from the in-vehicle communication apparatus 10. The relay function determination unit 23 is able to determine whether the roadside communication apparatus 3 has a function of relaying communication, by receiving the function list information transmitted from the roadside communication apparatus 3, and determining whether a communication relay function is included in this information.

The key information generation unit 24 performs processing for generating a private key for performing processing for encrypting data that will be transmitted outside of the vehicle 1 by the in-vehicle communication apparatus 10, and a public key for performing processing for decrypting data encrypted using this private key. Since the method of generating the private key and public key is existing technology, a detailed description is omitted. In the present embodiment, the key information of the private key and public key needs to be updated periodically, and the key information generation unit 24 updates the key information periodically in a predetermined cycle, such as daily, weekly or monthly, for example. In the case where new key information is generated by the key information generation unit 24, the certificate information acquisition unit 21 acquires digital certificate information corresponding to the new key information.

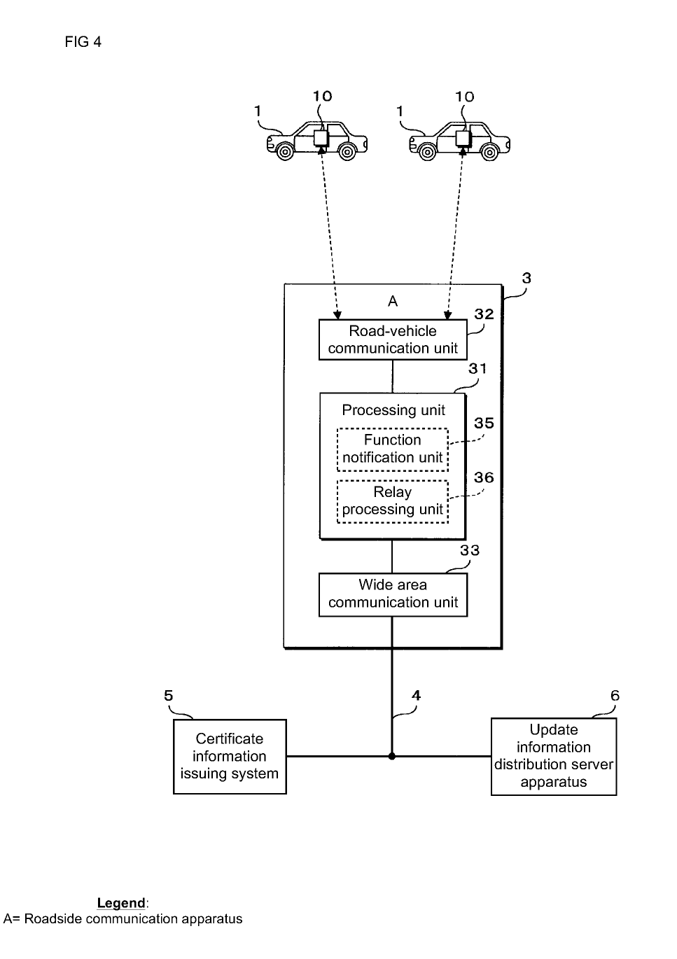

FIG. 4 is a block diagram showing the configuration of the roadside communication apparatus 3. The roadside communication apparatus 3 according to the present embodiment is constituted to be provided with a processing unit 31, a road-vehicle communication unit 32, a wide area communication unit 33 and the like. The processing unit 31 is constituted using a computational processing unit such as a CPU, and performs various types of computational processing related to communication. The road-vehicle communication unit 32 wirelessly communicates with the in-vehicle communication apparatus 10 mounted in the vehicle 1. The road-vehicle communication unit 32 performs data transmission to the in-vehicle communication apparatus 10 by outputting a signal obtained through modulating data for transmission provided by the processing unit 31 from an antenna, and also receives data from the in-vehicle communication apparatus 10 by demodulating signals received with the antenna and provides the received data to the processing unit 31. The wide area communication unit 33 communicates with a server apparatus that is administered by a traffic management center, for example, the certificate information issuing system 5 and the update information distribution server apparatus 6 described above, and the like, via a network 4 such as the Internet. The wide area communication unit 33 transmits data for transmission provided by the processing unit 31 to the server apparatus and the like connected to the network 4, and also receives data transmitted from server apparatus and the like and provides the received data to the processing unit 31.

Also, the processing unit 11 of the roadside communication apparatus 3 according to the present embodiment is provided with functional blocks such as a function notification unit 35 and a relay processing unit 36. The function notification unit 35 performs processing for transmitting, by road-vehicle communication, list information of the functions that the roadside communication apparatus 3 can provide to the vehicle 1, in response to an inquiry from the vehicle 1. The functions that can be provided by the roadside communication apparatus 3 can include, for example, a function of informing the operating condition of the traffic light 2 and a function of informing traffic information such as road congestion conditions. Also, in the present embodiment, the roadside communication apparatus 3 has a relay function of relaying communication between the in-vehicle communication apparatus 10 and the certificate information issuing system 5, the update information distribution server apparatus 6 and the like. The relay processing unit 36 performs processing for transmitting data received from the in-vehicle communication apparatus 10 with the road-vehicle communication unit 32 to the certificate information issuing system 5 or the update information distribution server apparatus 6 with the wide area communication unit 33. Also, the relay processing unit 36 performs processing for transmitting data received from the certificate information issuing system 5 or the update information distribution server apparatus 6 with the wide area communication unit 33 to the in-vehicle communication apparatus 10 with the road-vehicle communication unit 32.

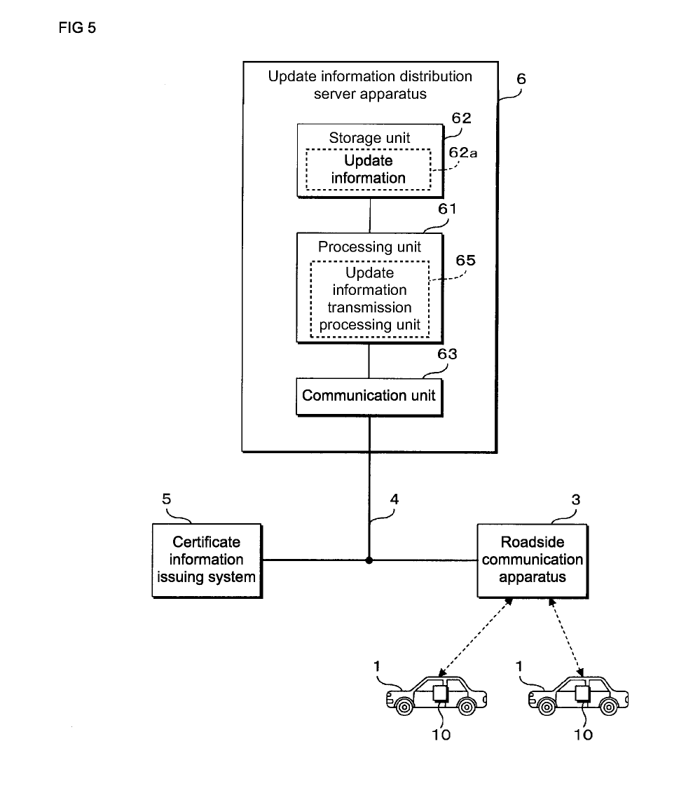

FIG. 5 is a block diagram showing the configuration of the update information distribution server apparatus 6. The update information distribution server apparatus 6 according to the present embodiment is constituted to be provided with a processing unit 61, a storage unit 62, a communication unit 63 and the like. The processing unit 61 is constituted using a computational processing unit such as a CPU, and performs various types of computational processing related to distribution of update information, by executing programs stored in the storage unit 62. The storage unit 62 is constituted using a storage device such as a hard disk, for example, and stores programs that are executed by the processing unit 61 and various types of data required in processing by the processing unit 61. In the present embodiment, the storage unit 62 stores update information 62a relating to a change (increase/decrease in server apparatuses, etc.) in the system configuration of the certificate information issuing system 5. Note that the update information 62a may, for example, be generated by one of the server apparatuses that is included in the certificate information issuing system 5 and transmitted to the update information distribution server apparatus 6, or may be created by the update information distribution server apparatus 6 automatically or based on operations by an administrator or the like. The communication unit 63 communicates with the roadside communication apparatus 3, the certificate information issuing system 5 and the like, via a network 4 such as the Internet. The communication unit 63 transmits data for transmission provided by the processing unit 61 to the roadside communication apparatus 3 and the like connected to the network 4, and also receives data from the roadside communication apparatus 3 and the like and provides the received data to the processing unit 61.

Also, an update information transmission processing unit 65 and the like are realized as software-based functional blocks in the processing unit 61 of the update information distribution server apparatus 6 according to the present embodiment, by executing programs stored in the storage unit 62. The update information transmission processing unit 65 performs processing for transmitting the update information 62a stored in the storage unit 62 to the in-vehicle communication apparatus 10 of the vehicle 1, in response to a request made by the in-vehicle communication apparatus 10 via the roadside communication apparatus 3.

### Update Information Transmission Processing

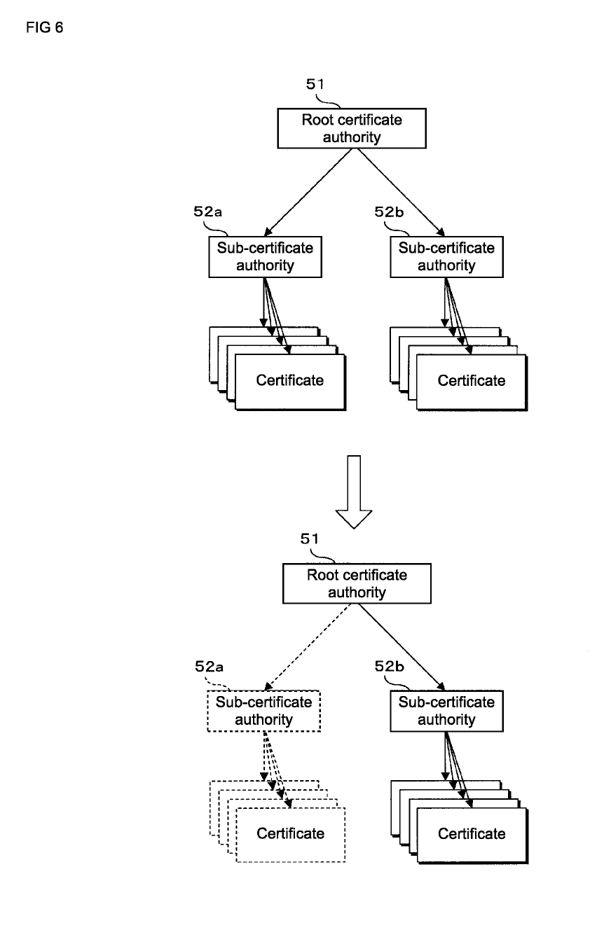

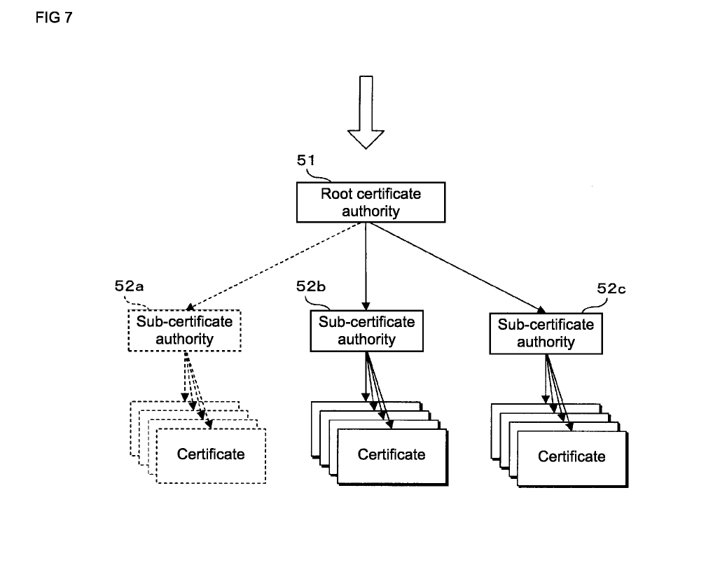

FIGS. 6 and 7 are schematic diagrams showing exemplary changes in the configuration of the certificate information issuing system 5. For example, assume that, at a certain point in time, the one root certificate authority 51 and the two sub-certificate authorities 52a and 52b were included in the certificate information issuing system 5 (refer to upper part of FIG. 6). The root certificate authority 51 issues digital certificate information for the two sub-certificate authorities 52a and 52b, and the two sub-certificate authorities 52a and 52b issue digital certificate information for each of a plurality of in-vehicle communication apparatus 10.

In the case where a sub-certificate authority 52a is removed for whatever reason, all of the digital certificate information issued by this sub-certificate authority 52a will need to be revoked (refer to lower part of FIG. 6). If such a situation arises, the update information distribution server apparatus 6 stores information indicating that the sub-certificate authority 52a has been removed in the storage unit 62 as the update information 62a. This update information 62a can be referred to as a so-called CRL (Certificate Revocation List). The update information distribution server apparatus 6 is able to transmit the CRL, in response to a request from the in-vehicle communication apparatus 10.

Furthermore, in the case where a new sub-certificate authority 52c is added, this sub-certificate authority 52c starts issuance of digital certificate information to the in-vehicle communication apparatus 10 (refer to FIG. 7). The in-vehicle communication apparatus 10 could possibly receive data to which an electronic signature including digital certificate information issued by the sub-certificate authority 52c is attached from another in-vehicle communication apparatus 10. The in-vehicle communication apparatus 10 thus needs to acquire information for determining the validity of the digital certificate information issued by the sub-certificate authority 52c, that is, digital certificate information issued for the sub-certificate authority 52c by the root certificate authority 51. In view of this, the update information distribution server apparatus 6 stores information indicating that the sub-certificate authority 52c has been newly added, electronic signature information of this sub-certificate authority 52c and the like in the storage unit 62 as the update information 62a.

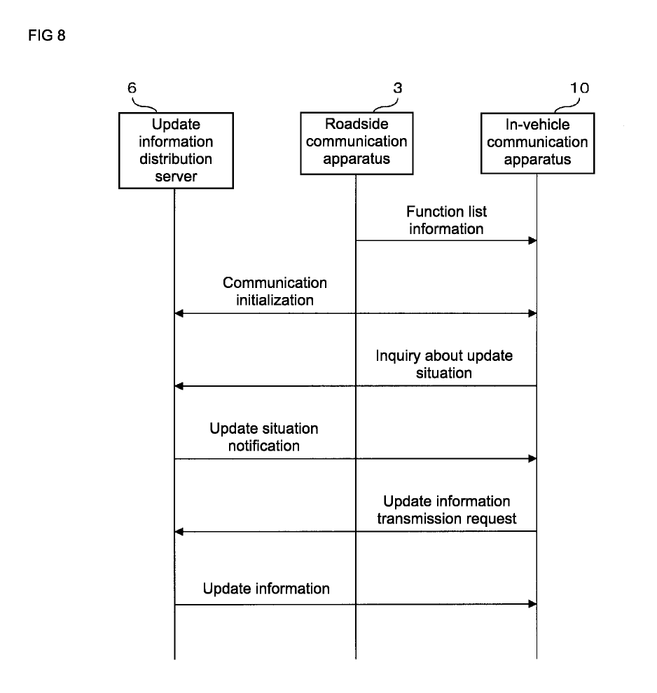

FIG. 8 is a timing chart for illustrating processing for transmitting update information. The roadside communication apparatus 3 repeatedly transmits list information of the functions that it can provide continuously, for example. If the in-vehicle communication apparatus 10 enter within communication range of the roadside communication apparatus 3 due to the vehicle 1 travelling, the in-vehicle communication apparatus 10 is able to receive, with the road-vehicle communication unit 15, the function list information that is transmitted by the roadside communication apparatus 3. The in-vehicle communication apparatus 10, having received the function list information from the roadside communication apparatus 3, determines whether this roadside communication apparatus 3 has a relay function. If the roadside communication apparatus 3 has a relay function, the in-vehicle communication apparatus 10 utilizes the relay function of the roadside communication apparatus 3, and starts communication with the update information distribution server apparatus 6 via the roadside communication apparatus 3. At this time, the in-vehicle communication apparatus 10 first performs communication initialization processing such as establishing a communication session or authentication processing, for example, with the update information distribution server apparatus 6.

After ending the communication initialization processing, the in-vehicle communication apparatus 10 makes an inquiry to the update information distribution server apparatus 6 about the updating situation of the system configuration of the certificate information issuing system 5. The update information distribution server apparatus 6, having received this inquiry, notifies the in-vehicle communication apparatus 10 whether there is an update of the system configuration of the certificate information issuing system 5. If notification indicating that there is an update is received from the update information distribution server apparatus 6, the in-vehicle communication apparatus 10 makes a request for transmission of update information to the update information distribution server apparatus 6. The update information distribution server apparatus 6, having received this request, reads out the update information 62a stored in the storage unit 62, and transmits the read update information 62a to the in-vehicle communication apparatus 10.

Having received the update information from the update information distribution server apparatus 6, the in-vehicle communication apparatus 10, in the case where the digital certificate information of a newly added sub-certificate authority is included in the received update information, determines whether the received update information is valid, by determining whether this digital certificate information is valid. Whether the digital certificate information of the sub-certificate authority is valid can be determined, by performing verification using the public key of the root certificate authority that issued this digital certificate information. If it is determined the digital certificate information of the sub-certificate authority is valid, the in-vehicle communication apparatus 10 stores the received update information in the storage unit 12.

Note that, in this example, a configuration is adopted in which the in-vehicle communication apparatus 10 makes a request for transmission of update information after making an inquiry to the update information distribution server apparatus 6, but the present disclosure is not limited thereto. A configuration may be adopted in which the in-vehicle communication apparatus 10 makes a request for transmission of update information to the update information distribution server apparatus 6 without making an inquiry. In this configuration, the update information distribution server apparatus 6, in the case where there is not an update of the system configuration of the certificate information issuing system 5, can provide notification that there is not an update or transmit update information including information indicating that there is not an update, in response to the request for transmission of update information.

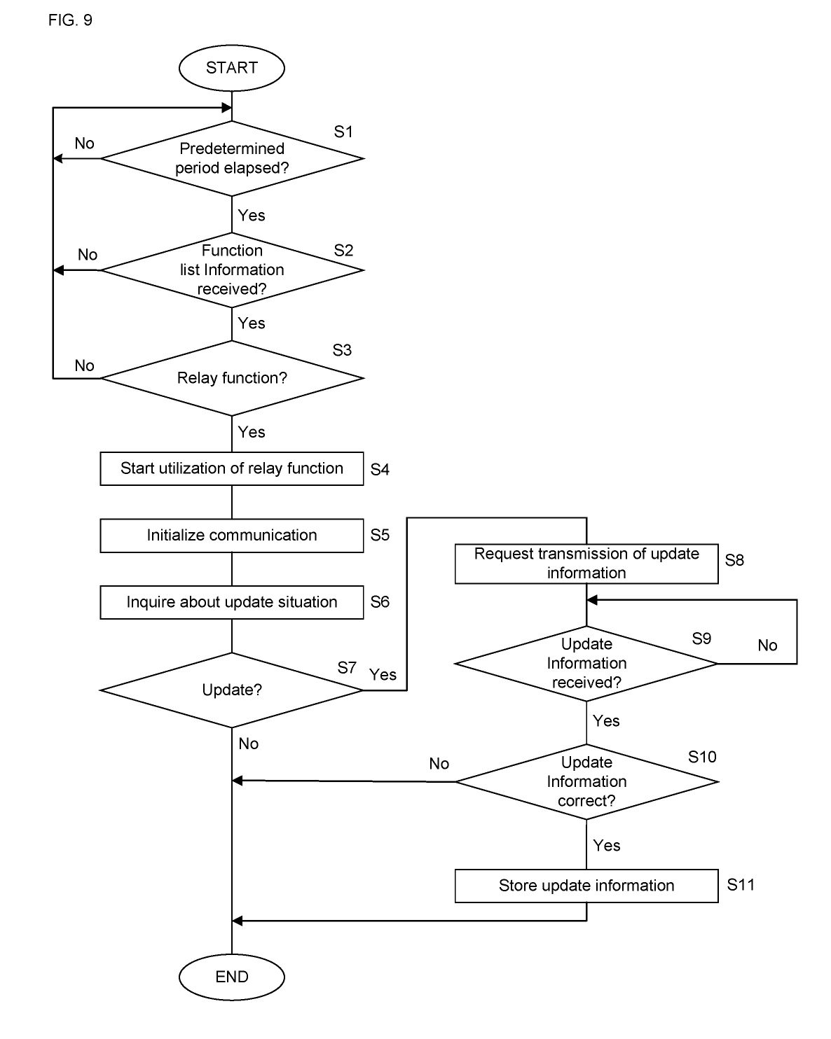

FIG. 9 is a flowchart showing the procedure of update information acquisition processing that is performed by the in-vehicle communication apparatus 10. The processing unit 11 of the in-vehicle communication apparatus 10 determines whether a predetermined period such as one day, one week or one month, for example, has elapsed since the last update information acquisition (step S1). If the predetermined period has not elapsed (S1: NO), the processing unit 11 waits until the predetermined period elapses. If the predetermined period has elapsed (S1: YES), the relay function determination unit 23 of the processing unit 11 determines whether function list information has been received from the roadside communication apparatus 3 with the road-vehicle communication unit 15 (step S2). If function list information has not been received (S2: NO), the relay function determination unit 23 returns the processing to step S1. If function list information has been received from the roadside communication apparatus 3 (S2: YES), the relay function determination unit 23 determines whether the roadside communication apparatus 3 has a relay function, based on the received function list information (step S3). If the roadside communication apparatus 3 does not have a relay function (S3: NO), the relay function determination unit 23 returns the processing to step S1. If the roadside communication apparatus 3 has a relay function (S3: YES), the processing unit 11 starts utilization of the relay function of the roadside communication apparatus 3, by performing processing such as switching to a communication channel for utilizing the relay function, for example.

Thereafter, the update information acquisition unit 22 of the processing unit 11 performs communication initialization processing with the update information distribution server apparatus 6, utilizing the relay function of the roadside communication apparatus 3 (step S5). After the end of the communication initialization processing, the update information acquisition unit 22 makes an inquiry about the updating situation relating to the system configuration of the certificate information issuing system 5 to the update information distribution server apparatus 6 (step S6). The update information acquisition unit 22 determines whether there is a system update of the certificate information issuing system 5, based on the response from the update information distribution server apparatus 6 to the inquiry (step S7). If there is not an update (S7: NO), the update information acquisition unit 22 ends the processing.

If there is an update (S7: YES), the update information acquisition unit 22 makes a request for transmission of update information to the update information distribution server apparatus 6 (step S8). Thereafter, the update information acquisition unit 22 determines whether update information from the update information distribution server apparatus 6 has been received (step S9), and if update information has not been received (S9: NO), waits until update information is received. The update information acquisition unit 22, having received update information, determines whether the received update information is valid (step S10). For example, the update information acquisition unit 22 is able to determine whether the update information is valid, by determining whether the digital certificate information of the sub-certificate authority that is included in the received update information is valid. If the update information is not valid (S10: NO), the update information acquisition unit 22 discards this information and ends the processing. If the update information is valid (S10: YES), the update information acquisition unit 22 stores the received update information in the storage unit 12 (step S11), and ends the processing.

### In Summary

In the communication system according to the present embodiment having the above configuration, the in-vehicle communication apparatus 10 mounted in the vehicle 1 acquires, via the roadside communication apparatus 3 installed on the road, update information related to an increase or decrease in the system configuration of the certificate information issuing system 5 from the update information distribution server apparatus 6. The in-vehicle communication apparatus 10 is thereby able to communicate with the update information distribution server apparatus 6 via the roadside communication apparatus 3 and acquire update information, in the case where the vehicle 1 enters within wireless communication range of the roadside communication apparatus 3, while the vehicle 1 is travelling or the like.

Also, information relating to an increase in the sub-certificate authorities (sub-server apparatuses) of the certificate information issuing system 5 is included in the update information that is acquired from the update information distribution server apparatus 6. In this case, digital certificate information created by the root certificate authority for the added sub-certificate authority can be included in the update information. The in-vehicle communication apparatus 10, having received update information, is thereby able to transmit and receive data including digital certificate information that is created by the added sub-certificate authority.

Also, in this case, the in-vehicle communication apparatus 10 determines the validity of the digital certificate information of the sub-certificate authority that is included in the acquired update information, based on the certificate information (public key) of the root certificate authority that issued this digital certificate information. The reliability of the digital certificate information of a sub-certificate authority that is newly acquired can thereby be enhanced.

Also, information relating to a decrease in the sub-certificate authorities of the certificate information issuing system 5, such as information that is able to distinguish which of the sub-certificate authorities has been invalidated, for example, is included in the update information that is acquired from the update information distribution server apparatus 6. The in-vehicle communication apparatus 10, having received update information, is thereby able to perform processing such as discarding and not using digital certificate information issued by the invalidated sub-certificate authority in subsequent communication or discarding received data to which digital certificate information issued by the invalidated sub-certificate authority is attached, enabling the reliability of communication to be improved.

Also, the in-vehicle communication apparatus 10, in the case where the road-vehicle communication unit 15 becomes communicable with the roadside communication apparatus 3, acquires function list information from the roadside communication apparatus 3, and determines whether this roadside communication apparatus 3 has a relay function. The in-vehicle communication apparatus 10 is thereby able to efficiently communicate with the update information distribution server apparatus 6, according to the functions of the roadside communication apparatus 3.

Also, the in-vehicle communication apparatus 10 acquires update information from the update information distribution server apparatus 6 periodically in a predetermined cycle, such as daily, weekly or monthly, for example. The in-vehicle communication apparatus 10 is thereby able to periodically grasp the latest configuration of the certificate information issuing system 5.

Note that, in the present embodiment, the certificate information issuing system 5 is provided with a two-level configuration constituted by the root certificate authority 51 and the sub-certificate authorities 52a to 52c, but the present disclosure is not limited thereto. For example, the certificate information issuing system may be provided with a three-level configuration constituted by a root certificate authority, a plurality of first sub-certificate authorities whose digital certificate information is issued by the root certificate authority, and a plurality of second sub-certificate authorities whose digital certificate information is issued by the first sub-certificate authorities. Furthermore, the certificate information issuing system may be provided with a configuration having four or more levels. Also, in the present embodiment, the update information distribution server apparatus 6 is provided separately from the certificate information issuing system 5, but the present disclosure is not limited thereto. For example, the root certificate authority 51 or one of the sub-certificate authorities 52a to 52c may additionally have the function of the update information distribution server apparatus 6. Also, although a single update information distribution server apparatus 6 manages both an increase and a decrease in sub-certificate authorities, the present disclosure is not limited thereto, and a configuration may be adopted in which different server apparatuses manage an increase and a decrease in sub-certificate authorities.

Also, although the in-vehicle communication apparatus 10 is provided with the vehicle-vehicle communication unit 14 that performs vehicle-vehicle communication, the present disclosure is not limited thereto, and a configuration may be adopted in which vehicle-vehicle communication is not performed. Also, the in-vehicle communication apparatus 10 may be further provided with a wireless communication function such as a mobile phone communication network or a wireless LAN, for example. Also, the vehicle-vehicle communication unit 14 that performs vehicle-vehicle communication and the road-vehicle communication unit 15 that performs road-vehicle communication may be mounted in the vehicle 1 as separate apparatuses to the in-vehicle communication apparatus 10, rather than being provided in the in-vehicle communication apparatus 10. Also, the roadside communication apparatus 3 is provided in the traffic light 2 on the road, but is not limited thereto, and may be provided in an on-road installation other than the traffic light 2.

### Modifications

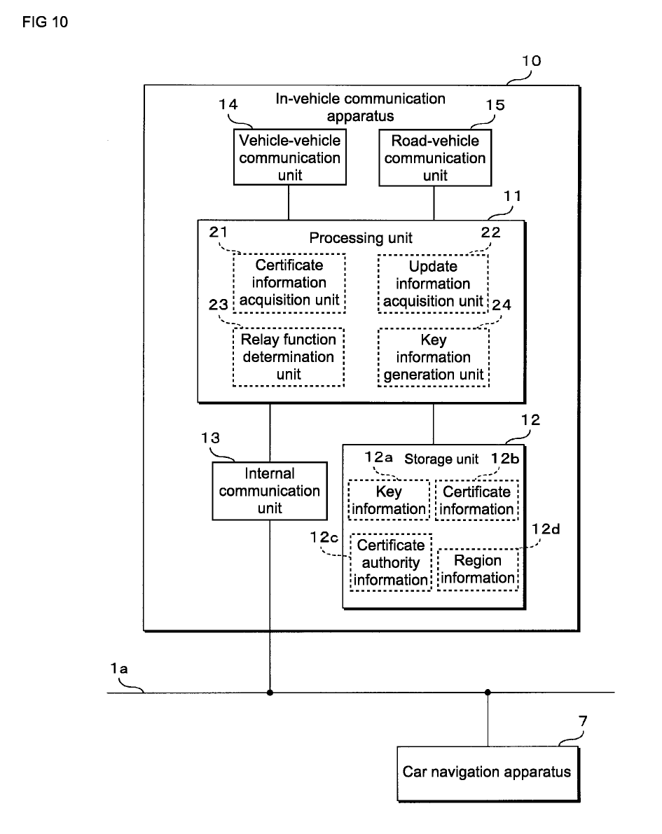

The in-vehicle communication apparatus 10 according to a modification is configured to acquire update information that depends on position information of a vehicle. FIG. 10 is a block diagram showing the configuration of the in-vehicle communication apparatus 10 according to the modification. The in-vehicle communication apparatus 10 according to the modification communicates with a car navigation apparatus 7 mounted in the vehicle 1 using the internal communication unit 13. The car navigation apparatus 7 is an apparatus that specifies the position of the vehicle 1 based on information that is obtained from GPS, a gyro sensor or the like, and performs route guidance to a destination input by a user. The car navigation apparatus 7 transmits the position information of the vehicle 1 to the internal network 1a, and the in-vehicle communication apparatus 10 acquires the position information of the vehicle 1 (e.g., latitude, longitude, etc.) transmitted by the car navigation apparatus 7 with the internal communication unit 13.

In the communication system according to the modification, regions in which the plurality of sub-certificate authorities 52a to 52c that are included in the certificate information issuing system 5 are respectively in charge of issuing digital certificate information have been determined. For example, a sub-certificate authority is provided for each specific region such as the Kanto region and the Kansai region in Japan, and issues digital certificate information for vehicles 1 that are situated in that region. The in-vehicle communication apparatus 10 stores information for distinguishing the region in which each sub-certificate authority is in charge in the storage unit 12 as region information 12d. The in-vehicle communication apparatus 10 is able to determine which sub-certificate authority is in charge of the region in which the vehicle 1 is situated, by comparing the position information of the vehicle 1 acquired from the car navigation apparatus 7 with the region information 12d stored in the storage unit 12.

The in-vehicle communication apparatus 10 according to the modification repeatedly acquires position information from the car navigation apparatus 7 while the vehicle 1 is travelling, and repeatedly determines which sub-certificate authority is in charge of the region in which the vehicle 1 is situated. In the case where the vehicle 1 moves from the region in which one sub-certificate authority is in charge to a region in which another sub-certificate authority is in charge, the in-vehicle communication apparatus 10 communicates with the update information distribution server apparatus 6 via the roadside communication apparatus 3, and acquires update information from the update information distribution server apparatus 6. The in-vehicle communication apparatus 10 is thereby able to acquire update information in the case of having moved to a region in which another sub-certificate authority is in charge due to the movement of the vehicle 1, and correctly grasp the configuration of the certificate information issuing system 5, and is thus able to smoothly perform processing such as communication with another sub-certificate authority.

Note that update information acquisition processing of the in-vehicle communication apparatus 10 according to the modification can be realized by determining whether the vehicle 1 has moved to a region in which another sub-certificate authority is in charge, instead of determining whether a predetermined period has elapsed, in step S1 of the flowchart shown in FIG. 9. Note that the in-vehicle communication apparatus 10 may perform both acquisition of update information every predetermined period and acquisition of update information that depends on the position information of the vehicle 1.

1. A communication system comprising an in-vehicle communication apparatus mounted in a vehicle, a low-order server apparatus configured to create digital certificate information to be used by the in-vehicle communication apparatus in communication, and a high-order server apparatus configured to create digital certificate information related to the low-order server apparatus, the communication system further comprising:
a roadside communication apparatus installed on a road, and configured to perform wireless communication with the in-vehicle communication apparatus; and
an update information distribution server apparatus configured to distribute update information related to an increase or decrease in low-order server apparatuses,
wherein the in-vehicle communication apparatus includes:
a wireless communication unit configured to wirelessly communicate with the roadside communication apparatus;
an update information acquisition unit configured to acquire update information from the update information distribution server apparatus via the roadside communication apparatus; and
a relay function determination unit configured to wirelessly communicate with the roadside communication apparatus, using the wireless communication unit, and determine whether the roadside communication apparatus has a function of relaying communication with the update information distribution server apparatus.

2. The communication system according to claim 1,
wherein the update information that is acquired by the update information acquisition unit is information relating to an increase in low-order server apparatuses, and includes certificate information created by the high-order server apparatus for an added low-order server apparatus.

3. The communication system according to claim 2,
wherein the in-vehicle communication apparatus includes a certificate information determination unit configured to, in a case where the update information acquisition unit acquires update information, determine a validity of certificate information of the low-order server apparatus included in the update information, based on certificate information of the high-order server apparatus.

4. The communication system according to claim 1,
wherein the update information that is acquired by the update information acquisition unit is information related to a decrease in low-order server apparatuses, and includes information related to an invalidated low-order server apparatus.

5. (canceled)

6. The communication system according to claim 1,
wherein the update information acquisition unit periodically acquires the update information.

7. The communication system according to claim 1,
wherein the in-vehicle communication apparatus includes a position information acquisition unit configured to acquire position information of the vehicle, and
the update information acquisition unit acquires the update information according to the position information that is acquired by the position information acquisition unit.

8. An in-vehicle communication apparatus to be mounted in a vehicle and configured to perform communication using digital certificate information created by at least one low-order server apparatus for which a high-order server apparatus creates digital certificate information, comprising:
a wireless communication unit configured to wirelessly communicate with a roadside communication apparatus installed on a road;
an update information acquisition unit configured to acquire update information related to an increase or decrease in low-order server apparatuses and/or high-order server apparatuses from an update information distribution server apparatus configured to distribute the update information, via the roadside communication apparatus; and
a relay function determination unit configured to wirelessly communicate with the roadside communication apparatus, using the wireless communication unit, and determine whether the roadside communication apparatus has a function of relaying communication with the update information distribution server apparatus.

9. The communication system according to claim 2, wherein the update information that is acquired by the update information acquisition unit is information related to a decrease in low-order server apparatuses, and includes information related to an invalidated low-order server apparatus.

10. The communication system according to claim 3, wherein the update information that is acquired by the update information acquisition unit is information related to a decrease in low-order server apparatuses, and includes information related to an invalidated low-order server apparatus.

11. The communication system according to claim 2, wherein the update information acquisition unit periodically acquires the update information.

12. The communication system according to claim 3, wherein the update information acquisition unit periodically acquires the update information.

13. The communication system according to claim 4, wherein the update information acquisition unit periodically acquires the update information.

14. The communication system according to claim 2, wherein the in-vehicle communication apparatus includes a position information acquisition unit configured to acquire position information of the vehicle, and the update information acquisition unit acquires the update information according to the position information that is acquired by the position information acquisition unit.

15. The communication system according to claim 3, wherein the in-vehicle communication apparatus includes a position information acquisition unit configured to acquire position information of the vehicle, and the update information acquisition unit acquires the update information according to the position information that is acquired by the position information acquisition unit.

16. The communication system according to claim 4, wherein the in-vehicle communication apparatus includes a position information acquisition unit configured to acquire position information of the vehicle, and the update information acquisition unit acquires the update information according to the position information that is acquired by the position information acquisition unit.

17. The communication system according to claim 6, wherein the in-vehicle communication apparatus includes a position information acquisition unit configured to acquire position information of the vehicle, and the update information acquisition unit acquires the update information according to the position information that is acquired by the position information acquisition unit.
